(19) United States
(12) Patent Application Publication
(10) Pub. No.: US 2004/0117107 A1
(43) Pub. Date: Jun. 17, 2004

(54) Method for detecting accident

(76) Inventor: Bong Keun Lee, Gyeonggi-do (KR)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 10/689,458

(22) Filed: Oct. 20, 2003

(30) Foreign Application Priority Data
Dec. 13, 2002 (KR) 79443/2002

(51) Int. Cl. G08G 1/00

(52) U.S. Cl. 701/117

(57) ABSTRACT

Disclosed is a method for detecting a car accident capable of improving reliability in accident determination using a road density. The method for detecting a car accident computes a road density difference value using road densities respectively detected from two points and computes a road density average value and a road density upper critical limit using the road density difference values computed for a predetermined period of time, respectively. At the moment, if the present road density average value is larger than the previous road density upper critical limit for a predetermined period of time, an accident is determined to have occurred.

### BACKGROUND OF THE INVENTION

1. Field of the Invention

The present invention relates to a method for detecting a car accident on a road and more particularly to a method for detecting a car accident on a road in a more reliable manner.

2. Background of the Related Art

Dictionary definition of an “accident” is an unfortunate event or circumstance.

More specifically, a car accident means “an unfortunate event or happening occurring on a road, or all accidents that reduce capacity of a road such as a traffic accident, disorder or stoppage of a vehicle, a fallen object, and maintenance work”.

In case that such accident occurs in a road, it is required to quickly inform a traffic control center of such accident. Up to now, car accidents have usually been reported by drivers of passing-by vehicles who happened to witness the accidents.

Even after a car accident report is made, it takes time to control and pull over a vehicle (or vehicles) involved in the accident out of the spot. Therefore, lots of vehicles have had great difficulty for a long time.

Particularly, in a country like Korea where distribution costs and shipment are very expensive and heavily dependent on terrestrial transportation, occurrence of such accident has emerged as a serious problem.

Under these circumstances, a method for detecting a car accident, capable of checking the presence of an accident vehicle on the road, has been suggested recently.

Namely, the recently suggested method for detecting a car accident, detects a car accident by extracting occupying ratio from a vehicle detector and using change transition of the extracted occupying ratio.

For a vehicle detector, a video detector, an infrared detector, a loop detector, a RF (Radio Frequency) detector, a radar detector, an ultrashort wave detector, etc. may be used.

By such vehicle detector, traffic information such as whether a vehicle exists, traffic amount, speed, a vehicle length, an occupying ratio, is computed.

The related art method has detected a car accident using an occupying ratio among such traffic information.

At the moment, the occupying ratio is given by the formula 1 as follows:

Occupying ratio=Number of Vehicles within Image/Road Length within Image [Formula 1]

For example, computation of the occupying ratio using a video detector is performed as follows. On the first place, an image is obtained by a video detector, and a number of vehicles passing through a plurality of video loops set in advance along a lane within the obtained image is computed, whereby a number of vehicles within the image is computed. At the moment, a road length for a region on a road which could be photographed by the video camera should be known in advance.

Therefore, as shown in the formula 1, a number of vehicles within an image are divided by a road length within an image, whereby the occupying ratio within an image is computed.

The occupying ratios computed in this manner, is averaged for a predetermined period of time, so that an occupying ratio average value and an occupying ratio upper critical limit are computed, respectively.

At the moment, if an occupying ratio average value is larger than an occupying ratio upper critical limit, a car accident is determined to have occurred.

In the meantime, in some cases, the vehicles reduce in their speed but intervals between the vehicles get crowded even more than before and a number of the vehicles within an image often increase. In that case, the occupying ratio increases due to increase of a number of the vehicles, but actually the vehicle is not in an accident condition.

FIG. 1 is a graph of experiment data obtained according to the method for detecting a car accident using the occupying ratio of the related art.

As shown in FIG. 1, the occupying ratio distribution fluctuates very much with respect to time on the whole.

Also, an interval C where an average value 5 for the occupying ratio computed through averaging of an occupying ratio up to before a specific time point, is larger than an upper critical limit 6 for the occupying ratio, which is given as a critical limit, so that the interval determined to be in an accident condition, is observed.

But, actual speed of the vehicles in the interval C is 8 km/h, and the vehicles were moving constantly.

Such fallacy is caused because the only occupying ratio is considered simply. Though a car accident does not occur, a car accident is determined, by mistake, to have occurred due to an increased occupying ratio as the intervals between the vehicles get narrow.

As revealed above, according to the method for detecting a car accident of the related art, a fatal problem that an only number of vehicles is considered and a car accident is determined to have occurred as far as the occupying ratio increases and larger than a predetermined critical limit, has been generated.

### SUMMARY OF THE INVENTION

An object of the invention is to solve at least the above problems and/or disadvantages and to provide at least the advantages described hereinafter.

Accordingly, one object of the present invention is to solve the foregoing problems by providing a method for detecting an accident capable of improving reliability even more by exactly detecting a car accident using a road density.

Such road density could be obtained by a video detector, an infrared detector, a loop detector, a RF (Radio Frequency) detector, a radar detector, an ultrashort wave detector, etc.

According to the preferred embodiment of the present invention, a method for detecting an accident includes the steps of: computing a road density difference value between two points on a road; computing a road density average value and a road density upper critical limit using the computed road density difference value; and determining an accident through comparison of the road density average value with a previous road density upper critical limit for a predetermined period of time.

According to another preferred embodiment of the present invention, a method for detecting an accident includes the steps of: detecting traffic information from vehicles passing through two points on a road, respectively; computing a road density average value and a road density upper critical limit, respectively, using the detected traffic information; and determining an accident through comparison of the road density average value with the road density upper critical limit.

According to still another preferred embodiment of the present invention, a method for detecting an accident includes the steps of: computing road density values between two points on a road using traffic information detected from the two points on a road; computing a road density average value and a road density upper critical limit, respectively, using the computed road density values; and determining an accident through comparison of the road density average value with a previous road density upper critical limit for a predetermined period of time.

### BRIEF DESCRIPTION OF THE DRAWINGS

The above objects, features and advantages of the present invention will become more apparent from the following detailed description when taken in conjunction with the accompanying drawings, in which:

FIG. 1 is a graph of experiment data performed according to the method for detecting an accident using the occupying ratio of the related art.

FIG. 2 is a drawing explaining a road density upon occurrence of an accident according to a preferred embodiment of the present invention.

FIG. 3 is a flowchart explaining the method for detecting an accident according to a preferred embodiment of the present invention.

FIG. 4 is a flowchart explaining a method for computing a road density upper critical limit of FIG. 3.

FIG. 5 is a graph for experiment data performed according to the method for detecting an accident using a road density according to a preferred embodiment of the present invention.

### DETAILED DESCRIPTION OF PREFERRED EMBODIMENTS

The following detailed description will present a method for detecting an accident according to a preferred embodiment of the invention in reference to the accompanying drawings.

FIG. 2 is a drawing explaining a road density upon occurrence of an accident according to a preferred embodiment of the present invention.

Referring to FIG. 2, a congestion interval (region A) where a road density increases are formed on the left with respect to the point where an accident occurs, while a swift transportation interval (region B) where a road density decreases are formed on the right with respect to the point where an accident occurs on a road.

At the moment, a detecting means is provided to the region A and the region B, respectively, so that traffic information for the relevant region is detected. Here, for the detecting means, one among a video detector, an infrared detector, a loop detector, a magnetic detector, a RF (Radio Frequency) detector, a radar detector, an ultrashort wave detector, may be used.

Namely, traffic information for computing a road density value of each point is detected from the detecting means. At the moment, the traffic information includes a number of the vehicles and speeds of the vehicles.

The road density computed in this manner on the basis of the traffic information for each interval is given by the formula 2 as follows:

$${d}_{i , t} = \frac{{V}_{i , t}}{{S}_{i , t}} \qquad [ Formula 2 ]$$

Here, di,t, Vi,t, Si,t stand for a road density, a number of vehicles, speed, respectively. Also, i stands for an arbitrary point and t stands for an arbitrary time.

As shown in the formula 2, a value obtained by dividing a number of vehicles by speed, represents a road density at an arbitrary point and time.

Therefore, the present invention could judge occurrence of an accident between two points by constantly observing each road density between arbitrary two points for a predetermined period of time. Also, the present invention could prevent, in advance, fallacy of determining the relevant point as an accident point though vehicles are moving in constant speed, by adding speed concept to the circumstance that could be determined to have caused an accident.

More specifically, a road density difference value is computed from road densities computed for the two points with use of the formula 3 as follows:

Δdt=d1,t−d2,t [Formula 3]

Here, Δdt stands for a road density difference value between two points, d1,t stands for a road density value for a region B, and d2,t stands for a road density value for a region A.

As shown in formula 3, a road density difference value between two points at an arbitrary time represents difference between a road density value at one point (a region B) and a road density value at other point (a region A).

If the road density difference value is computed, a road density average value is computed with use of the road density difference value computed in this manner. Namely, the road density average value is expressed by the formula 4 as follows:

$$m t = \frac{Δ {d}_{t - 4} + Δ {d}_{t - 3} + Δ {d}_{t - 2} + Δ {d}_{t - 1} + Δ {d}_{t}}{5} \qquad [ Formula 4 ]$$

Here, mt stands for an average value of road density differences between arbitrary two points, for a predetermined period of time, e.g., 5 seconds. Also, Δdt stands for a present road density difference, Δdt−1 stands for a road density difference before 1 second, Δdt−2 stands for a road density difference before 2 seconds, Δdt−3 stands for a road density difference before 3 seconds, and Δdt−4 stands for a road density difference before 4 seconds.

The present invention computes the road density average value on the basis of 5 seconds, but 3 seconds or 10 seconds could also be used for the basis depending on circumstances.

Therefore, the road density average value represents an average value for the road density difference values computed for a predetermined period of time.

A road density upper critical limit is computed with use of the road density average value computed by the formula 4, and is expressed by the formula 5 as follows:

UCLt=μt+3σt [Formula 5]

Here, UCLt stands for a road density upper critical limit, representing a critical limit for comparison with the road density average value. Also, μt stands for an average value of the road density average values for a predetermined period of time, e.g., 5 seconds, and is expressed by the formula 6 as follows:

$$μ t = \frac{{m}_{t - 4} + {m}_{t - 3} + {m}_{t - 2} + {m}_{t - 1} + {m}_{t}}{5} \qquad [ Formula 6 ]$$

Here, mt stands for a present road density average value, mt−1 stands for a road density average value before 1 second, mt−2 stands for a road density average value before 2 seconds, mt−3 stands for a road density average value before 3 seconds, mt−4 stands for a road density average value before 4 seconds.

Therefore, the road density average value μt for a predetermined period of time represents an average value for the road density average values computed for a predetermined period of time.

Also, a standard deviation σt is expressed by the formula 7 as follows:

$$σ , t = \sqrt{\frac{\begin{matrix}{( {m}_{t - 4} - {μ}_{t} )}^{2} + {( {m}_{t - 3} - {μ}_{t} )}^{2} + {( {m}_{t - 2} - {μ}_{t} )}^{2} + \\ {( {m}_{t - 1} - {μ}_{t} )}^{2} + {( {m}_{t} - {μ}_{t} )}^{2}\end{matrix}}{5}} \qquad [ Formula 7 ]$$

In formula 5, 3σt stands for weight, and may be set by three times the standard deviation. Preferably, the weight may be set by two and a half through three times the standard deviation.

In order to guarantee the road density upper critical limit minimally, in case the weight 3σt is smaller than

$$\frac{μ}{2} ,$$

it is preferable to set the weight by

$$\frac{μ}{2} .$$

Roughly, the weight may be set by 0.3 through 0.7 times the average value μt of the road density average values for a predetermined period of time.

This is for improving reliability of accident determination even in case that road traffic condition abruptly changes frequently such as the case of rush hours in the morning.

At the moment, accident condition is determined through comparison of a present road density average value mt with a previous road density upper critical limit UCLt.

Namely, if a present road density average value is larger than a previous road density upper critical limit, accident condition is determined. In other words, the fact that a present road density average value is larger than a previous road density upper critical limit, means that the present road density is more increased than before.

At the moment, in order for more accurate accident determination, if the present road density average value constantly remains larger than the previous road density upper critical limit for a predetermined period of time, accident is determined to have occurred.

Such procedure is for preventing fallacy of falsely determining accident condition even in case of non-accident condition, by erroneously determining accident condition for the case that the present road density average value is temporarily larger than the previous road density upper critical limit.

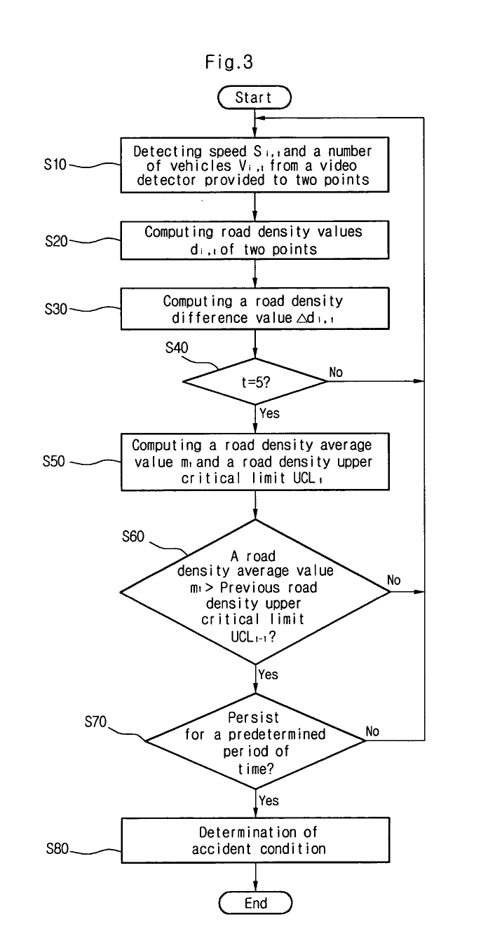

The method for detecting an accident according to the present invention will be described in detail with reference to FIG. 3.

FIG. 3 is a flowchart explaining the method for detecting an accident according to a preferred embodiment of the present invention.

Referring to FIG. 3, on the firstly place, traffic information including speed and a number of vehicles are detected from the video detector provided to two points (S 10).

The present embodiment uses the video detector in detecting traffic information, but the traffic information could also be detected through one of an infrared detector, a loop detector, a magnetic detector, a RF (Radio Frequency) detector, a radar detector, an ultrashort wave detector.

The road density values at each point are computed with use of a number of vehicles and speed computed in this manner, according to the formula 2 (S 20).

Also, the road density difference value Δdt is computed with use of the road density value differences computed at each point, according to the formula 3 (S 30).

The steps of S 10 through S 30 are performed for 5 seconds (S 40).

Through such steps, five road density difference values Δdt, Δdt−1, Δdt−2, Δdt−3, Δdt−4 are computed.

Then, the road density average value mt and the road density upper critical limit UCLt are computed, respectively, with use of the road density difference values computed for 5 seconds by the step of S 40, according to the formula 4 and the formula 5 (S 50).

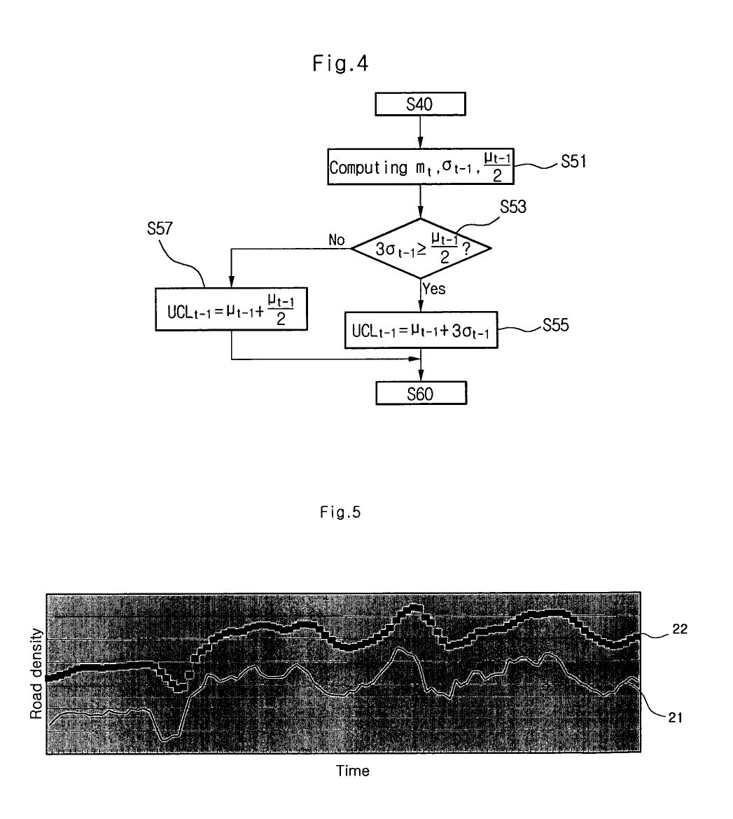

At the moment, procedure of computing the road density upper critical limit UCLt will be described in more detail with reference to FIG. 4.

FIG. 4 is a flowchart explaining a method for computing the road density upper critical limit of FIG. 3.

Referring to FIG. 4, the road density average value mt for 5 seconds, the standard deviation σt−1 before the road density average value, and

$$\frac{μ t - 1}{2}$$

are computed, respectively (S 51).

At the moment, whether weight 3σt−1 is equal to or larger than

$$\frac{μ t - 1}{2} ,$$

is judged (S 53).

If the weight is equal to or larger than

$$\frac{μ t - 1}{2} ,$$

a value obtained by addition of the weight 3σt−1 to an average value μt−1 for a predetermined period of time before 1 second of the road density difference value, is computed for the road density upper critical limit UCLt−1 (S 55).

If the weight is smaller than

$$\frac{μ t - 1}{2} ,$$

a value obtained by addition of the weight

$$\frac{μ t - 1}{2}$$

to an average value μt−1 for a predetermined period of time before 1 second of the road density difference value, is computed for the road density upper critical limit UCLt−1 (S 57).

Referring to FIG. 3 again, whether a present road density average value mt is larger than a previous road density upper critical limit UCLt−1, is judged (S 60).

If a present road density average value mt is smaller than a previous road density upper critical limit UCLt−1 as a result of the judgment, the step is returned to the step of S 10.

On the contrary, if a present road density average value mt is larger than a previous road density upper critical limit UCLt−1 as a result of the judgment, whether such condition persists for a predetermined period of time, is judged (S 70).

If condition that a present road density average value mt is larger than a previous road density upper critical limit UCLt−1 persists for a predetermined period of time, an accident condition is determined (S 80).

If accident condition is determined in this manner, a predetermined alarming signal is emanated to a manager so that proper steps could be taken for the accident condition.

FIG. 5 is a graph for experiment data obtained according to the method for detecting an accident using a road density according to a preferred embodiment of the present invention.

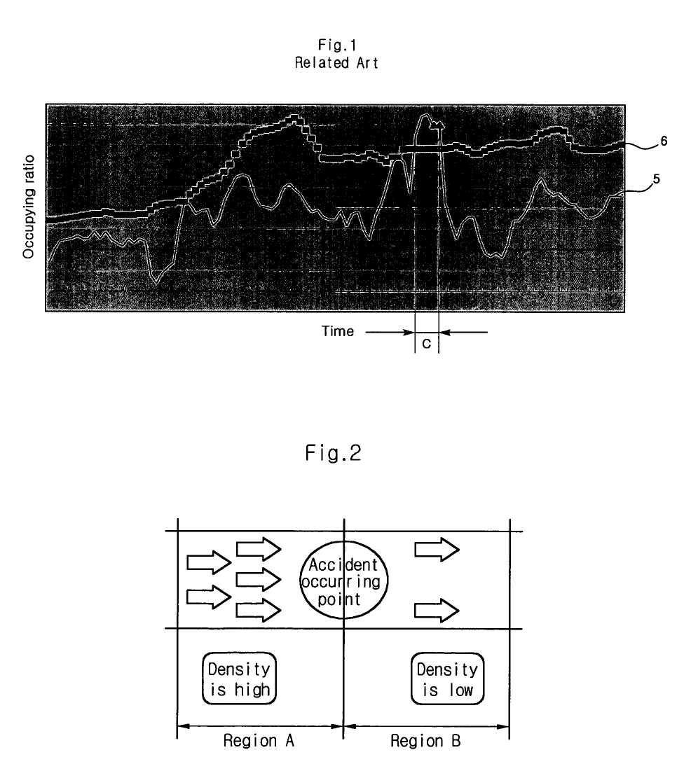

FIG. 5 is a graph showing results of detecting an accident under the same condition as FIG. 1.

An accident is detected with use of the road density in FIG. 5, not the occupying ratio in FIG. 1.

As shown in FIG. 5, it is revealed that at the interval C that has been determined to be accident condition in FIG. 1, the road density average value 21 is smaller than the previous road density upper critical limit 22, so that the interval C does not fall on accident condition at this time.

Also, the road density upper critical limits 22 are distributed at the position apart a predetermined distance from the road density average values 21 in each time.

At the moment, the distribution of the road density average value 21 does not fluctuate very much with respect to time. On the contrary, the average values of the occupying ratio change very unstably with respect to time.

Therefore, the related art method for detecting a car accident using the occupying ratio, has a problem of erroneously determining accident condition for non-accident condition, for the occupying ratio average values change very unstably with respect to time, while in the method for detecting a car accident using the road density according to the present invention, the road density average values change in a stable manner with respect to time, so that fallacy of falsely determining accident condition could be minimized.

As is apparent from the foregoing, according to the method for detecting a car accident of the present invention, an accident is detected with use of the road density differences between two points, whereby fallacy of falsely determining accident condition is minimized and reliability is improved as much as that.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for detecting an accident comprising the steps of:
computing a road density difference value between two points on a road;
computing a road density average value and a road density upper critical limit using the computed road density difference value; and
determining an accident through comparison of the road density average value with a previous road density upper critical limit for a predetermined period of time.

2. The method according to claim 1, wherein the road density difference value is computed from traffic information detected by detecting means respectively provided to the two points on the road.

3. The method according to claim 2, wherein the detecting means is one of a video detector, an infrared detector, a loop detector, a magnetic detector, a RF (Radio Frequency) detector, a radar detector, an ultrashort wave detector.

4. The method according to claim 2, wherein the traffic information includes a number of vehicles and speed.

5. The method according to claim 1, wherein the road density difference value is a difference between road density values computed from traffic information respectively detected from the two points.

6. The method according to claim 1, wherein the road density average value is an average value of the road density difference values for a predetermined period of time.

7. The method according to claim 1, wherein the road density upper critical limit is a value obtained by addition of predetermined weight to an average value of the road density average values for a predetermined period of time.

8. The method according to claim 7, wherein if the weight is equal to or larger than a half of the average value of the road density average values for a predetermined period of time, the weight is set by two and a half through three times a standard deviation.

9. The method according to claim 7, wherein if the weight is smaller than a half of the average value of the road density average values for a predetermined period of time, the weight is set by 0.3 through 0.7 times the average value of the road density average values for a predetermined period of time.

10. A method for detecting an accident comprising the steps of:
detecting traffic information from vehicles passing through two points on a road, respectively;
computing a road density average value and a road density upper critical limit, respectively, using the detected traffic information; and
determining an accident through comparison of the road density average value with the road density upper critical limit.

11. The method according to claim 10, wherein the step of determining an accident further comprises the steps of:
judging whether condition that the road density average value is larger than a previous road density upper critical limit, persists for a predetermined period of time; and
if the condition persists for a predetermined period of time, determining accident condition.

12. The method according to claim 10, wherein the traffic information is detected by one of a video detector, an infrared detector, a loop detector, a magnetic detector, a RF (Radio Frequency) detector, a radar detector, an ultrashort wave detector.

13. The method according to claim 10, wherein the road density average value is an average value of the road density difference values for a predetermined period of time.

14. The method according to claim 13, wherein the road density difference value is a difference between road density values computed from the traffic information respectively detected from the two points.

15. The method according to claim 10, wherein the road density upper critical limit is a value obtained by addition of predetermined weight to an average value of the road density average values for a predetermined period of time.

16. The method according to claim 15, wherein if the weight is equal to or larger than a half of the average value of the road density average values for a predetermined period of time, the weight is set by two and a half through three times a standard deviation.

17. The method according to claim 15, wherein if the weight is smaller than a half of the average value of the road density average values for a predetermined period of time, the weight is set by 0.3 through 0.7 times the average value of the road density average values for a predetermined period of time.

18. A method for detecting an accident comprising the steps of:
computing road density values between two points on a road using traffic information detected from two points on a road;
computing a road density average value and a road density upper critical limit, respectively, using the computed road density values; and
determining an accident through comparison of the road density average value with a previous road density upper critical limit for a predetermined period of time.

19. The method according to claim 18, wherein if the road density average value is larger than the road density upper critical limit for a predetermined period of time, an accident is determined to occur.

20. The method according to claim 18, wherein the traffic information is detected by one of a video detector, an infrared detector, a loop detector, a magnetic detector, a RF (Radio Frequency) detector, a radar detector, an ultrashort wave detector.

21. The method according to claim 18, wherein the road density average value is an average value of the road density difference values for a predetermined period of time.

22. The method according to claim 21, wherein the road density difference value is a difference between the computed road density values.

23. The method according to claim 18, wherein the road density upper critical limit is a value obtained by addition of predetermined weight to an average value of the road density average values for a predetermined period of time.

24. The method according to claim 23, wherein if the weight is equal to or larger than a half of the average value of the road density average values for a predetermined period of time, the weight is set by two and a half through three times a standard deviation.

25. The method according to claim 23, wherein if the weight is smaller than a half of the average value of the road density average values for a predetermined period of time, the weight is set by 0.3 through 0.7 times the average value of the road density average values for a predetermined period of time.
